(19) United States
(12) Patent Application Publication
(10) Pub. No.: US 2010/0323058 A1
(43) Pub. Date: Dec. 23, 2010

(54) METHOD FOR PRODUCING FISH PASTE PRODUCT, AND ENZYME PREPARATION FOR FISH PASTE PRODUCTS

(75) Inventors: Akiko MARUYAMA, Kawasaki-shi (JP); Hiroaki Sato, Kawasaki-shi (JP); Tomohiro Kodera, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: AJINOMOTO CO. INC, Tokyo (JP)

(21) Appl. No.: 12/862,892

(22) Filed: Aug. 25, 2010

Related U.S. Application Data
(63) Continuation of application No. PCT/JP2009/055571, filed on Mar. 16, 2009.

(30) Foreign Application Priority Data
Mar. 17, 2008 (JP) 2008-067037

(51) Int. Cl. A23L 1/325; A23J 3/34

(52) U.S. Cl. 426/7; 426/61; 426/643

(57) ABSTRACT

In the process of producing a fish paste product, adding a defined amount of a transglutaminase and ascorbic acid or a related compound thereof are added to material surimi can suppress changes in the physical properties of nerimi during the process of producing a fish paste product and a fish paste product having a preferable firmness and elasticity can be obtained even in the case of reducing the amount of material surimi.

### CROSS REFERENCES TO RELATED APPLICATIONS

This application is a continuation of International Patent Application No. PCT/JP2009/055571, filed on Mar. 16, 2009, and claims priority to Japanese Patent Application No. 067037/2008, filed on Mar. 17, 2008, both of which are incorporated herein by reference in their entireties.

### BACKGROUND OF THE INVENTION

1. Field of the Invention

The present invention relates to methods for producing a fish paste product. The present invention also relates to enzyme preparations useful for making a fish paste product. The present invention further relates to fish paste products produced by such a method.

2. Discussion of the Background

Fish paste products, such as boiled fish paste cakes, have been widely eaten as traditional food products in Japan. Recently, with growing concerns about health, the popularity of fish paste products has been increasing even in foreign countries including European nations and the U.S. Together, with the influence of the increase in the price of the oil, the price of surimi, which is a material for making a fish paste product, has been rising. For this reason, various attempts have been made to reduce the material cost. For example, one approach is to reduce the amount of surimi, making up for it by increasing the amount of water. In this approach, in order to reinforce the firmness and elasticity, starch, vegetable protein, albumen, alkali salt, and the like are used as auxiliary materials. However, with respect to the setting time for allowing an enzymatic reaction or chemical reaction to occur in kneaded fish paste nerimi (a kneaded mixture of surimi and other ingredients), a sufficient setting time cannot be taken in the production of some fish paste products, such as deep-fried fish paste cakes, requiring further reinforcement. In such a product, starch, vegetable protein, and albumen are not so effective, whereas when alkali salt or the like is added thereto in an amount that will be effective, this adversely influences the flavor.

It has been reported that by using enzymes such as a transglutaminase and an ascorbate oxidase in combination with alkali and auxiliary materials serving as the substrate, certain degrees of firmness and elasticity can be imparted (see, Japanese Patent No. 3702709). However, in the actual production line, there is a problem in that the quality differs between products of the initial flow and those in the final flow. It is believed to be because surimi used at the last is held longer after kneaded till shaped and heated, and the enzymatic reaction thus proceeds further, resulting in changes in the physical properties of nerimi (a kneaded mixture of surimi and other ingredients). Further, when the amount of enzyme added is so small that it only results in an acceptable change in the physical properties of nerimi during the production, the effects in imparting firmness and elasticity are insufficient. In particular, in the case of a deep-fried fish paste cake, because of the short time of the transglutaminase reaction, the amount of transglutaminase has to be increased. As a result, the physical properties change during the process of standing (while the nerimi is allowed to stand until the shaping/heating process during the production process).

Meanwhile, Surimi Technology, p. 291, published by Marcel Dekker Inc., 1992, describes that the addition of ascorbic acid to surimi increases the gel strength, and that the optimal amount of ascorbic acid added is 0.2% relative to surimi. However, as a result of investigation, the present inventors have confirmed that a product having 0.2% ascorbic acid has a texture with insufficient elasticity. It has also been reported that when natural calcium and sodium ascorbate are used to produce a tube-shaped fish paste cake, this results in improvised firmness and elasticity (see, JP-A-1-273566). Although this method solves the problems caused during the production process to some extent, it is still insufficient in terms of effectiveness in imparting elasticity, and results in a rubber-like, strange texture. This method is, thus, not suitable for the application to fish paste products.

For meat products, a technique using a transglutaminase, ascorbic acid, and polymerized phosphoric acid has been reported (see, Japanese Patent No. 3049966). However, regarding the use of ascorbic acid for fish paste products, no optimal amount is defined, and the effects achieved by the combined use remain unclear. Further, as described in the Examples, the proportion of transglutaminase relative to the amount of ascorbic acid is 0.000025 to 0.00005 g per unit of transglutaminase; this greatly differs from the range of the present invention. Therefore, none of the above techniques achieves the provision of a fish paste product with a sufficient level of desired firmness and elasticity while maintaining the production suitability. There thus is a demand for further improvement.

### SUMMARY OF THE INVENTION

Accordingly, it is one object of the present invention to provide novel methods for producing a fish paste product.

It is another object of the present invention to provide novel methods for producing a fish paste product, capable of suppressing changes in the physical properties of nerimi during the production process.

It is another object of the present invention to provide novel methods for producing a fish paste product, capable of suppressing changes in the physical properties of nerimi during the production process, even when a reduced amount of material surimi is used.

It is another object of the present invention to provide novel methods for producing a fish paste product, which provide a fish paste product with firmness and elasticity.

It is another object of the present invention to provide novel methods for producing a fish paste product, which provide a fish paste product with firmness and elasticity, even when a reduced amount of material surimi is used.

It is another object of the present invention to provide novel fish paste products produced by such a method.

It is another object of the present invention to provide novel enzyme preparations which are useful for producing a fish paste product.

These and other objects, which will become apparent during the following detailed description, have been achieved by the inventors' discovery of a method capable of suppressing variations in product quality due to the difference in the production time and also of, even in a system using a reduced amount of surimi, providing a fish paste product with firmness and elasticity. The method includes suitably combining a transglutaminase with ascorbic acid or a related compound thereof, preferably together with an α-glucosidase.

That is, the present invention provides:

1. A method for producing a fish paste product, wherein ascorbic acid or a related compound thereof and a transglutaminase are added.

2. A method according to the above Item 1, wherein further an α-glucosidase is added.

3. A method according to the above Item 1 or 2, wherein the amount of the ascorbic acid or a related compound thereof is 0.2 to 1.2 g per 1 kg of the material surimi, and the amount of the transglutaminase is 40 to 200 units per 1 kg of the material surimi.

4. A method according to the above Item 2 or 3, wherein the amount of the α-glucosidase is 1000 to 12000 units per 1 kg of the material surimi.

5. A method according to any one of the above Items 1 to 4, wherein the fish paste product is selected from the group consisting of a deep-fried fish paste cake, imitation crab, a tube-shaped fish paste cake, and a fish sausage.

6. An enzyme preparation for producing a fish paste product, containing ascorbic acid or a related compound thereof and a transglutaminase as active ingredients, wherein the amount of the ascorbic acid or a related compound thereof in the enzyme preparation is 0.002 to 0.03 g per 1 unit of the transglutaminase in the enzyme preparation.

7. An enzyme preparation according to the above Item 6, further containing as an active ingredient an α-glucosidase, wherein the amount of the α-glucosidase is 10 to 200 U per 1 unit of the transglutaminase.

8. A fish paste product, produced by a method according to Item 1.

### DETAILED DESCRIPTION OF THE PREFERRED EMBODIMENTS

As transglutaminases, those derived from mammals (see, JP-B-1-50382), those derived from fishes (see, Japanese Society of Fisheries Science, Heisei 3 (1991) Autumnal Conference, Proceedings, p. 180), those derived from plants, those derived from microorganisms (see, JP-A-1-27471, JP-A-11-75876), those produced by gene recombination (see, JP-A-1-300899), and so forth are known. The transglutaminase (hereinafter sometimes referred to as TG) used in the invention may be one derived from any source. An example thereof is a transglutaminase derived from microorganisms, which is commercially available from AJINOMOTO Co., Inc under the trade name “Activa” TG.

The ascorbic acid or a related compound thereof used in the present invention may be ascorbic acid, sodium ascorbate, ascorbic acid 2-glucoside, ascorbyl palmitate, ascorbyl stearate, or the like. Any of these may be used as long as it is food grade. Sodium ascorbate is the most preferable in terms of taste, etc.

The α-glucosidase (hereinafter sometimes referred to as AG) used in the present invention is an enzyme that hydrolyzes non-reducing terminal α-1,4-glucosidic linkages to produce α-glucose, and preferably has saccharide transfer activity to convert an α-1,4-linkage to an α-1,6 linkage. Such an α-glucosidase is called transglucosidase. That is, transglucosidase is an α-glucosidase enzyme with saccharide transfer activity. Glucoamylases react in a similar way to α-glucosidases; however, the resulting glucose is not α-glucose but β-glucose. Further, it is particularly important for an enzyme used in the invention to have not only hydrolysis activity but also saccharide transfer activity so that in the presence of a hydroxy-containing suitable acceptor, the enzyme converts an α-1,4-linkage in glucose to an α-1,6 linkage to produce a branched saccharide. An example of the α-glucosidase used in the present invention is an enzyme commercially available from AMANO ENZYME INC under the trade name Transglucosidase L “Amano”.

Examples of fish paste products herein include boiled fish paste cakes, deep-fried fish paste cakes, tube-shaped fish paste cakes, imitation crab, fish sausages, naruto, and hampen, as well as processed foods produced from seafood nerimi (a kneaded paste of seafood) such as Chinese steamed dumplings. Among these, the invention is particularly useful for products produced in a process with no setting time. The setting time herein means the time for intentional gelatinization of paste-like nerimi. When no setting time is taken, an enzymatic reaction has a large impact on the product during the transfer and accumulation of nerimi (a kneaded mixture of surimi and other ingredients) in the production line. This results in a problem in that even within the same lot, there are differences in physical properties and quality between products of the initial flow (products completed at the beginning) and those of a final flow (products completed near the end).

Typical examples of fish paste products produced taking no such setting time are deep-fried fish paste cakes, imitation crab, fish sausages, tube-shaped fish paste cakes, naruto, etc. Further, hampen, datemaki fish-paste omelet, and fish balls from fish meat are also included.

The material surimi herein means a ground paste of seafood, which is used as a material for making a fish paste product. Examples of fishes ordinarily used for the material surimi include Alaska pollack, Golden threadfin bream, Atka mackerel, lizard fish, shark, and sardine, but any kind of seafood is usable.

In the method for producing a fish paste product according to the invention, how to add ascorbic acid or a related compound thereof, TG, and AG is not limited as long as they are added to the material surimi prior to a heating process such as deep frying, steaming, or the like, and the order of addition is not limited either. For example, it is possible that an enzyme preparation containing ascorbic acid or a related compound thereof and TG or an enzyme preparation containing ascorbic acid or a related compound thereof, TG, and AG is prepared, and such an enzyme preparation is then added to the material surimi together with or separately from salt, seasonings, and other materials. Alternatively, it is also possible that without preparing an enzyme preparation, ascorbic acid or a related compound thereof, TG, and AG are separately added to the material surimi together with or separately from salt, seasonings, and other materials.

In the method for producing a fish paste product according to the present invention, the proper amount of TG to be added is 40 units to 200 units per 1 kg of material surimi. When the amount is less than 40 units, the addition is not sufficiently effective, while when the amount is more than 200 units, this results in variations in quality during the production process. The TG activity unit is measured and defined using a hydroxamate method as follows. That is, in a tris buffer having a pH of 6.0 at 37° C., TG is allowed to act in a reaction system having as the substrate benzyloxycarbonyl-L-glutamylglycine and hydroxylamine. In the presence of trichloroacetic acid, the resulting hydroxamic acid is converted to an iron complex. Next, the absorbance at 525 nm is measured to calculate the amount of hydroxamic acid from the calibration curve. The amount of enzyme that produced 1 μmol of hydroxamic acid in 1 minute is defined as a TGase activity unit, i.e., one unit (1 U) (see, JP-A-64-27471).

In the method for producing a fish paste product according to the present invention, the amount of ascorbic acid or a related compound thereof is 0.2 g to 1.2 g, preferably 0.4 g to 0.8 g, per kg of material surimi. When the amount of ascorbic acid or a related compound thereof is less than 0.2 g, such an amount is not effective, while an amount of more than 1.2 g results in a lack of elasticity of the texture. According to Surimi Technology, p. 291, published by Marcel Dekker, Inc., 1992, which has reported effects of ascorbic acid on surimi, the amount of ascorbic acid is 0.002 g to 0.03 g, preferably 0.002 g to 0.004 g, per unit of TG. When the amount is less than 0.1 g, desired firmness is not obtained, while when the amount is more than 3 g, elasticity imparted by TG is not perceived, resulting in a hard, fragile, rubber-like texture.

In the method for producing a fish paste product according to the present invention, the addition of an α-glucosidase provides the fish paste product with a smooth texture, thereby providing an even higher-quality fish paste product. Further, gelatinization of starch is accelerated, and, therefore, a larger amount of starch material can be used. In such a case, the amount of AG is preferably 500 to 50000 units, more preferably 1000 to 12000 units, per 1 kg of surimi. When the amount is less than 1000 units, the addition is not sufficiently effective, while when the amount is more than 12000 units, this results in strange stickiness. The AG activity unit was determined as follows. Specifically, 1 ml of 0.02 M acetic acid buffer (pH 5.0) was added to 1 ml of 1 mM α-methyl-D-glucoside, and 0.5 ml of the enzyme solution was added thereto. The mixture was allowed to act at 40° C. for 60 minutes, and the amount of enzyme that produced 1 μg of glucose in 2.5 ml of reaction mixtures was defined as 1 U (unit).

To TG and ascorbic acid or a related compound thereof are added, for example, AG, bulking agents like dextrin, starch, and the like, alkali materials like phosphates and the like, saccharides like glucose and the like, oxidoreductase like ascorbate oxidase and the like, a protein hydrolysate, a protein partial hydrolysate, an emulsifier, reducing agents like glutathione, cysteine, and the like, and other food additives. This provides an enzyme preparation for fish paste products in whose production the enzymatic reaction time is short.

The enzyme preparation according to the present invention may be in the form of a liquid, a paste, granules, or a powder.

The proportions of the ascorbic acid or a related compound thereof, TG, and AG in the enzyme preparation according to the invention are each more than 0% and less than 100%. It is preferable that the amount of TG is 1 to 200 units, the amount of ascorbic acid or a related compound thereof is 0.1 to 0.7 g of, and the amount of AG is 100 to 10000 units of per 1 gram of a preparation. The amount of ascorbic acid or a related compound thereof is preferably 0.002 to 0.03 g per 1 unit of TG. The amount of AG is preferably 10 to 200 U, more preferably 14 to 130 U, per 1 unit of TG.

Other features of the invention will become apparent in the course of the following descriptions of exemplary embodiments which are given for illustration of the invention and are not intended to be limiting thereof.

### EXAMPLES

### Example 1

Using the enzyme preparations shown in Table 1, deep-fried fish paste cakes of the formulation shown in Table 2 were prepared by the below-described method. As a control, a deep-fried fish paste cake (control sample 1) was prepared using the formulation shown in Table 3 (non-cost-saving formulation), in which the amount of surimi is 5% larger than in the formulation shown in Table 2 (cost-saving formulation). Further, as another control, another deep-fried fish paste cake was prepared (control sample 2) according to the same formulation as in Table 2, except for using no enzyme preparation.

TABLE 1
Formulation of Enzyme Preparation

| Materials (weight %) | TG 0% | TG 2% | TG 4% | TG 7% | TG 10% | TG 13% |
|---|---|---|---|---|---|---|
| Transglutaminase “Activa” TG | 0 | 2 | 4 | 7 | 10 | 13 |
| (manufactured by AJINOMOTO, | | | | | | |
| 1000 U/g) | | | | | | |
| α-Glucosidase “Transglucosidase L” | 0.5 | 0.5 | 0.5 | 0.5 | 0.5 | 0.5 |
| (manufactured by AMANO ENZYME, | | | | | | |
| 550000 U/g) | | | | | | |
| Sodium ascorbate (manufactured by | 25 | 25 | 25 | 25 | 25 | 25 |
| WELCOM) | | | | | | |
| Dextrin | 74.5 | 72.0 | 70.5 | 67.5 | 64.5 | 61.5 |
| TG activity/enzyme preparation 1 g (U/g) | 0 | 20 | 39 | 70 | 100 | 123 |
| AG activity/enzyme preparation 1 g (U/g) | 2549 | 2549 | 2549 | 2549 | 2549 | 2549 |

TABLE 2
Formulation of Deep-Fried Fish Paste
Cake (Cost-Saving Formulation)

| Materials | Proportion | to Surimi | Amount (g) |
|---|---|---|---|
| Alaska pollack (2nd grade) | 52.0% | 100% | 3120 |
| Potato starch | 8.0% | 15% | 480 |
| Salt | 1.1% | 2% | 66 |
| Sugar | 1.7% | 3% | 102 |
| “Ajinomoto” (MSG) | 0.3% | 1% | 18 |
| Enzyme preparation | 0.1% | 0.2% | 6.24 |
| Ice water | 36.9% | 71% | 2214 |
| Total | 100% | 192% | 6000 |

TABLE 3
Formulation of Deep-Fried Fish Paste
Cake (Non-Cost-Saving Formulation)

| Materials | Proportion | to Surimi | Amount (g) |
|---|---|---|---|
| Alaska pollack (2nd grade ) | 57.0% | 100% | 3420 |
| Potato starch | 8.0% | 14% | 480 |
| Salt | 1.1% | 2% | 66 |
| Sugar | 1.7% | 3% | 102 |
| “Ajinomoto” (MSG) | 0.3% | 1% | 18 |
| Ice water | 31.9% | 56% | 1914 |
| Total | 100.0% | 175% | 6000 |

First, 3120 g or 3420 g of crushed, frozen surimi of 2nd grade Alaska pollack was left to thaw at room temperature for 30 minutes. The partially thawed surimi was finely cut with a Stephan cutter (manufactured by STEPHAN, STEPHAN UM12). The cut surimi was stirred at low speed for 1 minute, and then at high speed for 2 minutes. To the resulting powder-like surimi were added salt and half the amount of ice water, and the mixture was stirred at low speed for 30 seconds. When the mixture started getting uniform as a whole, the speed was changed, and high-speed stirring was continued for 3 minutes. Subsequently, “Ajinomoto” (MSG), sugar, potato starch, and the remaining ice water were added to the stirred surimi, and the mixture was stirred at low speed for 30 seconds. When the mixture started getting uniform as a whole, the speed was changed, and high-speed stirring was performed. The high-speed stirring was stopped when the temperature of the surimi reached about 15° C. The surimi in this state is called nerimi (a kneaded mixture of surimi and other ingredients). The obtained nerimi was divided into 500-g portions, and mixing was performed with a spatula for 1 minute. In the case of adding a preparation, each preparation was added to the nerimi of the examined recipe in a proportion of 0.2% (0.6 g) relative to the surimi, and then mixed with a spatula for 1 minute. The preparation shown in Table 3 was produced and used to study the effects of the transglutaminase. The amount of sodium ascorbate in the preparation was fixed at 25% (relative to surimi, 0.05%).

Further, a portion of the nerimi was cut into an elliptical shape, and was deep fried in soybean refined oil at 140° C. for 2 minutes and at 170° C. for 2 minutes. About 80 g of the remaining nerimi was filled into a plastic cup. Immediately after filling and 90 minutes after filling (15° C.), the breaking strength was measured using a 25 mm spherical plunger. In order to determine the physical properties of the deep-fried fish paste cake, the breaking strength was measured using a 5 mm spherical plunger and a texture analyzer (manufactured by EKO INSTRUMENTS, TA-XT2i). The difference in breaking strength between the nerimi in 0 minute and that in 90 minutes was used as an index for changes in the physical properties of the nerimi during the production process. A greater difference was taken as indication of a greater change in physical properties. When the change in physical properties has no significant difference from the control sample 1, such a change was considered acceptable (n=3).

The deep-fried fish paste cakes were subjected to sensory evaluation. With respect to firmness and elasticity, the deep-fried fish paste cakes were rated from −2 to +2 in increments of 0.5, taking the standard recipe group as 0 (n=5). Firmness indicates the hardness perceived at the beginning of chewing, and elasticity indicates the stress perceived as one continues chewing. Regarding the scores in evaluations other than the overall evaluation, 0.5 indicates perception of a slight difference from the control sample 1, 1 indicates perception of a difference, 1.5 indicates perception of a large difference, and 2 indicates perception of an extremely large difference. In the overall evaluation, with respect to the desired texture and functions, one with optimal properties was evaluated as oo, one with sufficient properties was evaluated as o, one with not sufficient but acceptable properties was evaluated as Δ, and one failing to achieve the desired properties was evaluated as x.

The results of the physical property measurement and the sensory evaluation are shown in Table 4. As shown in Table 4, the physical properties of nerimi in the case of TG 4% were nearly equal to the results from the control sample 1. In the cases of TG 7% and TG 10%, the values thereof were not significantly different from the results from the control sample 1, but were larger than in the case of the control sample 1. Significant differences were confirmed between the values in the cases of TG 13% and TG 20% and the results from the control sample 1. ASNa in Table 4 represents sodium ascorbate

TABLE 4
Results of Physical Property Measurement and Sensory Evaluation for Deep-Fried Fish Paste Cakes

| | | | | Difference in Nerimi | Breaking Strength | | | Significant | |
|---|---|---|---|---|---|---|---|---|---|
| | Amount per kg of Surimi | | | Physical Property | of Deep-Fried Fish | | | Difference in | |
| Test | TG | ASNa | AG | Changes from Control | Paste Cake relative to | Sensory Evaluation | | Nerimi Physical | Overall |
| Samples | (U) | (g) | (u) | Sample 1(%) | Control Sample 1 (%) | Firmness | Elasticity | Property Changes | Evaluation |
| Control | 0 | 0 | 0 | 100 | 100 | 0 | 0 | — | ∘ |
| Sample 1 | | | | | | | | | |
| Control | 0 | 0 | 0 | 69 | 77 | −2 | −1.5 | Present | x |
| Sample 2 | | | | | | | | | |
| TG 0% | 0 | 0.5 | 5098 | 67 | 94 | −0.5 | −0.5 | Absent | x |
| TG 2% | 40 | 0.5 | 5098 | — | 99 | 0 | 0 | Absent | ∘ |
| TG 4% | 78 | 0.5 | 5098 | 97 | 101 | 0 | 0.5 | Absent | ∘∘ |
| TG 7% | 140 | 0.5 | 5098 | 122 | 102 | 0 | 0.5 | Absent | ∘∘ |
| TG 10% | 200 | 0.5 | 5098 | 139 | 101 | 0.5 | 0.5 | Absent | ∘ |
| TG 13% | 245 | 0.5 | 5098 | 171 | 100 | 1 | −0.5 | Present | x |
| TG 20% | 395 | 0.5 | 5098 | 222 | 97 | 1.5 | −1 | Present | x |

Meanwhile, in the cases of TG 2.5%, TG 4%, TG 7%, and TG10%, the results show that they were as effective as or more effective than the control sample 1 in terms of firmness, elasticity, dry texture, and breaking strength. In the cases of TG 13% and TG 20%, although their breaking strength was equal to or higher than that of the control sample 1, the results of sensory evaluation show that their elasticity was inferior to that of the control sample 1. This confirms that the addition of 0.5 g of sodium ascorbate, 5098 U of AG, and 40 to 200 U of TG per 1 kg of material surimi results in improved firmness and elasticity while maintaining the production suitability. This also confirms that in spite of the reduction in surimi proportion from 57% to 52%, a deep-fried fish paste cake with firmness and elasticity comparable to the case of not reducing the surimi proportion can be produced.

### Example 2

Using the enzyme preparations shown in Table 5, deep-fried fish paste cakes were prepared in the same manner as in Example 1, and were subjected to the physical property measurement and the sensory evaluation in the same manner as in Example 1. That is, the formulation for each deep-fried fish paste cake is the same as in Table 2, and the materials as well as control samples are the same as in Example 1. The amount of TG was 4.75% (86 U per kg of material surimi) so as to fall within the optimal amount range shown in the Example 1.

TABLE 5
Formulation of Enzyme Preparation

| Materials (weight %) | ASNA 0% | ASNa 10% | ASNa 20% | ASNa 30% | ASNa 40% | ASNa 60% | ASNa 80% | ASNa 100% |
|---|---|---|---|---|---|---|---|---|
| Transglutaminase | 4.75 | 4.75 | 4.75 | 4.75 | 4.75 | 4.75 | 4.75 | 0 |
| α-Glucosidase | 0.5 | 0.5 | 0.5 | 0.5 | 0.5 | 0.5 | 0.5 | 0 |
| Sodium ascorbate | 0 | 10 | 20 | 30 | 40 | 60 | 80 | 100 |
| Dextrin | 94.75 | 84.75 | 74.75 | 64.75 | 54.75 | 34.75 | 14.75 | 0 |

The results of the physical property measurement and the sensory evaluation are shown in Table 6. As shown in Table 6, regarding sodium ascorbate, in all the test samples, the changes in the physical properties of nerimi were smaller than in the case of the control sample 1. In the cases of ASNa 20%, ASNa 30%, ASNa 40%, and ASNa 60%, the results of the sensory evaluation and the physical property evaluation confirm that they were as effective as or more effective than the control sample 1. In the case of ASNa 10% (0.2 g per 1 kg of material surimi), although the results of the sensory evaluation thereof and their breaking strength were both inferior to those of the control sample 1, some improving effects were observed. However, in the cases of ASNa 80% and ASNa 100%, the products lacked elasticity. They provided a rubber-like, strange texture, showing small improving effects. ASNa in Table 6 represents sodium ascorbate.

TABLE 6
Results of Physical Property Measurement and Sensory Evaluation for Deep-Fried Fish Paste Cakes

| | | | | Difference in Nerimi | Breaking Strength | | | | |
|---|---|---|---|---|---|---|---|---|---|
| | Amount per kg of Surimi | | | Physical Property | of Deep-Fried Fish | | | | |
| Test | TG | ASNa | AG | Changes from Control | Paste Cake relative to | Sensory Evaluation | | | Overall |
| Samples | (U) | (g) | (u) | Sample 1(%) | Control Sample 1 (%) | Firmness | Elasticity | Note | Evaluation |
| Control | 0 | 0 | 0 | 100 | 100 | 0 | 0 | | ∘ |
| Sample 1 | | | | | | | | | |
| Control | 0 | 0 | 0 | 68 | 77 | −1.5 | −2 | | x |
| Sample 2 | | | | | | | | | |
| ASNa 0% | 86 | 0 | 5098 | 98 | 90 | −1 | −1 | | x |
| ASNa 10% | 86 | 0.2 | 5098 | — | 93 | −0.5 | −0.5 | | Δ |
| ASNa 20% | 86 | 0.4 | 5098 | 96 | 99 | 0 | 0.5 | | ∘∘ |
| ASNa 30% | 86 | 0.6 | 5098 | — | 99 | 0.5 | 0.5 | | ∘∘ |
| ASNa 40% | 86 | 0.8 | 5098 | 84 | 103 | 0.5 | 0 | | ∘ |
| ASNa 60% | 86 | 1.2 | 5098 | — | 109 | 1 | −0.5 | | Δ |
| ASNa 80% | 86 | 1.6 | 5098 | — | 108 | 1.5 | −0.5 | Rubber-like | x |
| | | | | | | | | texture | |
| ASNa 100% | 0 | 2.0 | 0 | 91 | 105 | 1.0 | −1 | Rubber-like | x |
| | | | | | | | | texture | |

This confirms that the addition of 86 U of transglutaminase and 0.2 g to 1.2 g of sodium ascorbate per 1 kg of material surimi results in a deep-fried fish paste cake with improved firmness and elasticity, and also that in spite of the reduction in surimi proportion from 57% to 52%, a deep-fried fish paste cake with firmness and elasticity comparable to the case of not reducing the surimi proportion can be produced.

### Example 3

Using the enzyme preparations shown in Table 7, deep-fried fish paste cakes were prepared in the same manner as in Example 1, and were subjected to the physical property measurement (except for the measurement of changes in the physical properties of nerimi) and the sensory evaluation in the same manner as in Example 1. That is, the formulation for each deep-fried fish paste cake is the same as in Table 2, and the materials as well as control samples are the same as in Example 1. The amount of TG was 4.0% (86 U per kg of material surimi) so as to fall within the optimal amount range shown in the Example 1, and the amount of sodium ascorbate was 30% (0.6 g per kg of material surimi) so as to fall within the optimal amount range shown in the Example 2.

TABLE 7
Formulation of Enzyme Preparation

| Materials (weight %) | AG 0.2% | AG 0.5% | AG 0.75% | AG 1% |
|---|---|---|---|---|
| Transglutaminase | 4.75% | 4.75% | 4.75% | 4.75% |
| α-Glucosidase | 0.20% | 0.50% | 0.75% | 1.00% |
| Sodium ascorbate | 30.00% | 30.00% | 30.00% | 30.00% |
| Dextrin | 65.05% | 64.75% | 64.5% | 64.25% |
| TG activity/enzyme | 43 | 43 | 43 | 43 |
| preparation 1 g (U/g) | | | | |
| AG activity/enzyme | 900 | 2549 | 4294 | 5506 |
| preparation 1 g (U/g) | | | | |

The results of the physical property measurement and the sensory evaluation are shown in Table 8. As the results of the sensory evaluation show in Table 8, in the cases of AG 0.2%, AG 0.5%, AG 0.75%, and AG 1%, the dry texture due to starch was ameliorated as compared with the control sample 2, resulting in a texture almost equal to the texture of the control sample 1. However, in the case of AG 1% (11012 U per 1 kg of material surimi), although some improving effects were confirmed, odd stickiness was slightly perceived.

This confirms that by adding 86 U of transglutaminase, 0.6 g of sodium ascorbate, and 1800 to 11012 U of α-glucosidase per 1 kg of material surimi, a deep-fried fish paste cake can be provided with improved firmness and elasticity, and a deterioration in texture (dryness) due to starch can be suppressed.

TABLE 8
Results of Physical Property Measurement and Sensory Evaluation for Deep-Fried Fish Paste Cakes

| | | | | Breaking Strength | | | | | |
|---|---|---|---|---|---|---|---|---|---|
| | Amount added to Surimi | | | of Deep-Fried Fish | | | | | |
| | TG | ASNa | AG | Paste Cake relative to | Sensory Evaluation | | | | Overall |
| | (U) | (g) | (U) | Control Sample 1 (%) | Firmness | Elasticity | Dryness | Note | Evaluation |
| Control | 0 | 0 | 0 | 100 | 0 | 0 | 0 | | ∘ |
| Sample 1 | | | | | | | | | |
| Control | 0 | 0 | 0 | 77 | −2 | −2 | −0.5 | | x |
| Sample 2 | | | | | | | | | |
| AG 0% | 86 | 0.6 | 0 | 103 | 0 | 0 | −0.5 | | Δ |
| AG 0.2% | 86 | 0.6 | 1800 | 105 | 0 | 0 | 0 | | ∘ |
| AG 0.5% | 86 | 0.6 | 5198 | 98 | −0.25 | 0 | 0 | | ∘∘ |
| AG 0.75% | 86 | 0.6 | 8588 | 104 | 0 | 0 | 0 | | ∘∘ |
| AG 1% | 86 | 0.6 | 11012 | 102 | 0 | 0 | 0 | Slightly sticky | ∘ |

### INDUSTRIAL APPLICABILITY

According to the present invention, even in the case of a deep-fried fish paste cake and like fish paste products in whose production the time for enzymatic reaction (setting time) is short, changes in the physical properties of nerimi during the production process can be suppressed, while achieving firmness and elasticity and suppressing a deterioration in texture (dryness) due to starch. Therefore, the amount of material surimi can be reduced. This thus is extremely useful in the food field.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method for producing a fish paste product, wherein ascorbic acid or a related compound thereof and a transglutaminase are added.

2. A method according to claim 1, wherein further an α-glucosidase is added.

3. A method according to claim 1, which comprises adding:
(a) ascorbic acid or a related compound thereof; and
(b) a transglutaminase,
to material surimi.

4. A method according to claim 3, wherein said ascorbic acid or a related compound thereof is added to said material surimi in an amount of 0.2 to 1.2 g per 1 kg of said material surimi, and said transglutaminase is added to said material surimi in an amount of 40 to 200 units per 1 kg of said material surimi.

5. A method according to claim 3, further comprising adding:
(c) an α-glucosidase,
to said material surimi.

6. A method according to claim 5, wherein said α-glucosidase is added to said material surimi in an amount of 1000 to 12000 units per 1 kg of said material surimi.

7. A method according to claim 5, wherein said ascorbic acid or a related compound thereof is added to said material surimi in an amount of 0.2 to 1.2 g per 1 kg of said material surimi, said transglutaminase is added to said material surimi in an amount of 40 to 200 units per 1 kg of said material surimi, and said α-glucosidase is added to said material surimi in an amount of 1000 to 12000 units per 1 kg of said material surimi.

8. A method according to claim 3, wherein said fish paste product is selected from the group consisting of a deep-fried fish paste cake, an imitation crab, a tube-shaped fish paste cake, and a fish sausage.

9. An enzyme preparation, comprising ascorbic acid or a related compound thereof and a transglutaminase, wherein said ascorbic acid or a related compound thereof is present in an amount of is 0.002 to 0.03 g per 1 unit of said transglutaminase in the enzyme preparation.

10. An enzyme preparation according to claim 9, which further comprises an α-glucosidase.

11. An enzyme preparation according to claim 10, wherein said α-glucosidase is present in an amount of 200 units per 1 gram of a preparation.

12. An enzyme preparation according to claim 10, wherein said ascorbic acid or a related compound is present in an amount of 0.002 to 0.03 g per 1 unit of said transglutaminase, and said α-glucosidase is present in an amount of 10 to 200 U per 1 unit of TG.

13. A fish paste product, which is prepared by a method which comprises adding:
(a) ascorbic acid or a related compound thereof; and
(b) a transglutaminase,
to material surimi.

14. A fish paste product according to claim 13, wherein said ascorbic acid or a related compound thereof is added to said material surimi in an amount of 0.2 to 1.2 g per 1 kg of said material surimi, and said transglutaminase is added to said material surimi in an amount of 40 to 200 units per 1 kg of said material surimi.

15. A fish paste product according to claim 13, wherein said method further comprises adding:
(c) an α-glucosidase,
to said material surimi.

16. A fish paste product according to claim 15, wherein said α-glucosidase is added to said material surimi in an amount of 1000 to 12000 units per 1 kg of said material surimi.

17. A fish paste product according to claim 15, wherein said ascorbic acid or a related compound thereof is added to said material surimi in an amount of 0.2 to 1.2 g per 1 kg of said material surimi, said transglutaminase is added to said material surimi in an amount of 40 to 200 units per 1 kg of said material surimi, and said α-glucosidase is added to said material surimi in an amount of 1000 to 12000 units per 1 kg of said material surimi.

18. A fish paste product according to claim 13, wherein said fish paste product is selected from the group consisting of a deep-fried fish paste cake, an imitation crab, a tube-shaped fish paste cake, and a fish sausage.
